(19) United States
(12) Patent Application Publication
(10) Pub. No.: US 2005/0053902 A1
(43) Pub. Date: Mar. 10, 2005

(54) Method for working out the behavioural strategy of a player using a cognitive virtual reality, device for carrying out said method and an information-carrying medium for said device

(76) Inventor: Utolin Konstantin Vladimirovich, Moscow (RU)

Correspondence Address: Galgano & Burke, 300 Rabro Drive, Suite 135, Hauppauge, NY, 11788, US

(21) Appl. No.: 10/490,243

(22) PCT Filed: Apr. 1, 2002
(86) PCT No.: PCT/RU02/00144

(30) Foreign Application Priority Data
Sep. 28, 2001 (RU) 2001126355

(51) Int. Cl. G09B 19/00; G06F 17/60

(52) U.S. Cl. 434/236; 434/219; 705/11

(57) ABSTRACT

This invention relates to means for working out behavioral strategy in diverse everyday-life situations, education, psychological training, as well as occupational selection and determining occupational fitness in various areas of activities. Technical problem to be solved by the present invention is to add to flexibility of a system of working out behavioral strategy of a personality such that said system can be built into now-existing systems without their cardinal modification. An individual psychophysical profile of a player's personality and matrix of event reaction thereof are determined by testing which can be performed either explicitly for the player before beginning the game, or in the course of the game, being unnoticed by the player when the tests are the game components. Next instructions for the game are generated taking account of these data. Thus, the entire course of the game is compared, from the very beginning of the game, with specific traits of player's personality. Program items that characterize the game characters, objects and definite processes are compared with the testing results concerning some or other characters, objects or processes of the game, thus investing the persons with the of a given particular player. In the course of the game itself, player's actions are traced and compared with the corresponding aspects of the individual psychophysical profile of the player's personality and of the matrix of the event reaction thereof. Games of the present type can be performed using both individual personal computers and using local or global telecommunication or computer networks of any type or kind.

This invention relates to means for working out behavioral strategy in diverse everyday-life situations, education, psychological training, as well as occupational selection and determining occupational fitness in various areas of activities using computation facilities and an appropriate data arrangement on information media. The invention can find utility when used for working out behavioral strategy using cognitive virtual reality (e.g., in a game), as well as for elaborating training and psychocorrecting simulators and games, and also adapting the now existing games for said purposes.

Behavioral strategy is in fact a set of methods and motivating factors of a player depending upon a sequence of origination of some everyday-life situations or other, or those arising in a game modeling various life aspects.

Known in the present state of the art is an improvement in computer games by adding educational means thereto. A software module is incorporated into a game program, or said module may be loaded into computer memory separately. Said module discontinues the game periodically, and an “inscribed picture” is displayed on the monitor's screen, asking a question that must be answered correctly so that the game game may be resumed not until a correct answer is made. Questions may be asked at a level which adapt itself to the abilities displayed by the player. When the player is incapable of answering the question within a predetermined lapse of time, a prompt is highlighted on the screen. If the player is still incapable of answering the question within a second predetermined lapse of time, an answer and explanation are displayed on the screen, whereupon the player may resume the game having entered the answer. Hence the faster is the player able to enter a correct answer the faster is he able to resume the game. The module may comprise security elements so as to prevent unauthorized deactivation thereof (cf. U.S. Pat. No. 6,024,572). The proposed apparatus is capable of teaching as well, but working out behavioral strategy as a set of methods and motivating factors of a player in this particular case by mastering ready-to-use recommendations is a very difficult task because questions are asked and recommendations are given without making allowance for personal peculiarities of a player.

Known in the art presently is a method of computer-aided assessing of a functional state of the object under test. The object being tested is subjected to a number of runs of test trials, whereupon there are recorded the control information and the information set on reproducing means; then both pieces of information are processed for their subsequent conversion into numerical data representing a functional state of the object under test. Next an individual numerical database is established for the object being tested against the results of a first run of test trials. In a sequence of said test trials each of the new runs thereof is used as a precedent run for a next run for establishing a current individual numerical database. Each of the next runs of the test trials is followed by correcting a precedent current individual numerical database against the numerical data of a new run of test trials so that when assessing a functional state of the object under test, use is made of a corrected current individual database as an individual standard for the object under test at a given instant of time (cf. RU Pat. #2,103,722, G06F 3/033, published on Jan. 27, 1998). Using the method under consideration one can successfully perform testing and assessing the state of a human being, whereas to obtain any recommendations concerned with personal peculiarities thereof seems to be impossible.

Known in prior art presently is a method for determining occupational fitness and psychological training of the officials of the law-enforcement bodies, said method comprising assessment of the parameters of the cardiovascular and respirator systems, attention and rate of response before and after psychophysical loads sustained. While imposing psychophysical loads an abrupt effect is produced of psychogenic and noise factors, whereupon galvanic skin resistance is additionally measured, as well as the examinee's decision is checked for correctness and memory, ability for logical thinking, and the time spent for performing individual steps of the task and said task as a whole are determined, whereupon the resultant indices are evaluated in points and the occupational fitness and psychological training of the examinee are determined against a sum total of the points.

In the course of training the subject under test may be subjected to the effect of a visual stimulus, e.g., a black-and-yellow one, as well as of auditional, tactile, and olfactory stimuli. In addition, there are measured the lapse of time spent for working out individual steps of the task and the time spent for performing the task as a whole, there are assessed correctness of the examinee's responses and decisions, as well as his/her ability for logical thinking, whereupon the resultant indices are evaluated in points and the occupational fitness is determined (cf. RU Pat. #2,089,101, A 61 B 5/16). However, the invention discussed above allows of only detecting whether or not the examinee is fitted for a given kind of activity. Fundamentally, one can execute a behavioral strategy but only within a specific preset sphere, whereas to go beyond its limits and simulate any everyday-life situations using said technical solution is impossible.

The closest analog to the herein-proposed invention is a method for correcting man's behavioral strategy and improving memory using virtual reality, wherein an individual psychophysical profile of a person and combinations of the “stimulus-reaction” variants (emotional patterns) hidden (“archived”) in the unconscious and memory of a subject. Testing is carried out by exposing the subject under test to the effect of various combinations of audio-visual, tactile, and other stimuli (irritants) and determining his/her reaction thereto. In this case, a number of physiological parameters of the subject interacting with the system are assessed and recorded, using a variety of sensors connected to a computer. Once a sui generis atlas (map) has been compiled of sets of reactions to some combinations of stimuli or other, a special set of symbols created by means of virtual reality and encoding some or other sets of reactions of a given particular subject is compared, using a definite procedure, to each of said sets of the atlas. Hence there is established a kind of a symbolic model of the “stimulus-reaction” sets which model characterizes an individual psychophysical profile of a subject and the structure of the “stimulus-reaction” sets archived in the memory thereof. Once said model has been created, an action program of the means of virtual reality aimed at establishing prescriptions, for a given particular subject, on dealing with some symbols or other, and sequences thereof, as well as transformation of symbolic sequences presented to him in virtual reality with a view to correcting man's behavioral strategy and improving memory thereof.. An apparatus for carrying said method into effect comprises a data carrier whereon there is recorded software for testing and correction, means for testing a player in order to determine an individual psychophysical profile of his/her personality and variants of the “stimulus-reaction” combinations (emotional patterns) hidden (“archived”) in individual's unconscious and memory, means making it possible to perform monitoring of physiological parameters and interpret reactions arising in the subject under test, and means of virtual reality for generating testing and correcting sequences, as well as combinations of various stimuli. The abovementioned means are realized in a method and apparatus for active symbolic self-constructing described in U.S. Pat. No. 6,097,927 published Aug. 1, 2000. It is necessary to point out that execution of behavioral strategy in the method under consideration is carried out by providing maximum possible effect on subject's sensations and perception created by the means of virtual reality of combined auditional-video-tactile images. This, on the hand, involves use of very complicated equipment and numerous auxiliaries whereby the system is sufficiently sophisticated and goal-oriented and hence costly and actually not readily available for widespread use. And, on the other hand, there occurs a large-scale invasion into man's psyche effected on the basis of a certain though rather complicated and optimized but fixed model. Both indirect and delayed sequels of such effects may be unpredictable enough, whereby a long-term monitoring of those parameters of psyche and memory which have been modified.

A technical result the attaining of which the present invention is aimed at is to add to flexibility of the system of working out behavioral strategy of a personality such that said system can be integrated into existing systems without the radical modification thereof, so as to provide a possibility of giving recommendations with respect to what behavioral strategies now exist for a human being in his psychophysical state and may exist in case of an optimum correction of man's psychophysical profile and of the matrix of event reaction thereof.

Said technical result is attained due to the provision of a special method for working out player's behavioral strategy using cognitive virtual reality, wherein individual psychophysical profile of a player's personality and matrix of event reaction thereof are determined by testing effected either explicitly for the player before beginning the game, or in the course of the game, being unnoticed by the player when the tests are the game components; an individual psychophysical profile of a player's personality and matrix of event reaction thereof are determined and instructions for playing the game are generated, while in the course of the game itself player's actions are traced and compared with the corresponding aspects of the individual psychophysical profile of the player's personality and matrix of the event reaction thereof; on the basis of said data there are then determined what player's personal qualities and combinations thereof have given one result or another; next said data are delivered together with recommendations for correcting player's behavioral strategy; there is formed, with due account of player's psychophysical profile and matrix of event reaction thereof, a character or a group of characters of the play and imparting to said character or group of characters the traits of player's individual psychophysical profile and matrix of event reaction thereof; there are established the game parameters taking into account said matrix and properties of player's individual psychophysical profile; there are determined, proceeding from player's manipulating game characters or any game objects, those game points which are key ones for a given particular player and determine actions selected by him/her and setting a further course of the game; actions performed by the player at said key points of the game and the state of the game; player's personal qualities are determined at said key points or combinations thereof yielding an appropriate result. Player's actions with respect to the game characters or any game objects, as well as state of game may be recorded at any game instant preselected by the player.

When working out player's behavioral strategy one may perform a retrospective step-by-step analysis of player's actions, determine what player's actions would be optimal at said game key points, and find combinations of components of individual psychophysical profile of player's personality and his/her matrix of event reaction thereof, which combinations have been to a maximum extent responsive for a non-optimal choice made by the player. There may be determined and generated new game conditions that do not replicate the precedent ones for replaying a game event or the game as a whole but with new psychological and psychophysical guidelines.

The method as claimed in any one of claims 1, 2, 3, and 4, CHARACTERIZED in that in the case of a number of game rounds or events thereof there are determined what combinations of components of individual psychophysical profile of player's personality and are inconsistent with successful individual's activity in the sphere of human activities simulated by the game or mediately associated therewith, whereupon the appropriate conclusions and recommendations are presented. An apparatus for working out player's behavioral strategy using cognitive virtual reality comprises a data carrier whereon there is recorded software for computer games, player's testing means for determining individual psychophysical profile of his/her personality and matrix of event reaction thereof, a means for generating instructions for the game, a means for monitoring player's actions with respect to the game characters or any game objects and comparing said actions with the definite aspects of the individual psychophysical profile of the player's personality and matrix of the event reaction thereof, a means for identifying personal qualities or combinations thereof yielding one result or another, and a means for establishing appropriate messages regarding player's psychophysical state and recommendations on correcting his/her behavioral strategy at key points of the game or, against player's request, at any other game instants and issuing appropriate messages to the player with or without interrupting the game, using appropriate linguistic formulas and visual aids built-in for issuing messages, without interrupting the game, to scenarios, topics, actions of characters, objects, graphic, audio and any other game components. The analyzing and correcting module is recorded on said data carrier or additional record carrier, said module being aimed at comparing and correlating the appropriate properties and parameters of individual psychophysical profile of player's personality and matrix of event reaction thereof with the game characters, objects and components in order to create a character or a group of characters of the game by imparting to said character or a group of characters the traits of individual psychophysical profile of player's personality and matrix of event reaction thereof, as well as those of the game objects and processes with due account of the above said traits, said module further comprising said means for monitoring player's actions with regard to the game characters or any objects thereof and comparing these with the aspects of individual psychophysical profile of player's personality and matrix of event reaction thereof, identifying personal qualities or combinations thereof resulting in selecting by the player some actions or other dictating one game course or another, creating, on the data carrier, appropriate messages and recommendations on correcting player's behavioral strategy, as well as a means for determining those game points which are key ones for a given particular player after which further game parameters and/or scenarios, ways of its organization, representation and interaction of game characters and objects, as well as means for game realization comprising graphic, audio and other components thereof, are determined depending on player's behavioral strategy displayed by him/her with regard to characters or other objects of the behavioral strategy depending on properties and parameters of player's psychophysical profile and matrix of event reaction thereof, generating instructions for recording player's actions and state of game at both said key points of the game and those arbitrarily selected by the player; the apparatus further comprises a storage means for recorded player's actions and state of game, while said means for identifying player's personal qualities or combinations thereof yielding an appropriate result, is capable of identifying said qualities or combinations thereof at any instant arbitrarily selected by the player and at key points of the game determined automatically by said analyzing and correcting module by comparing and correlating definite properties and parameters of an individual psychophysical profile of player's personality and matrix of event reaction thereof with both his/her actions regarding game characters and objects, and methods for organization, representation and interaction of the game characters or objects, as well as a means for game realization, including graphic, audio and any other game components and game parameters and/or scenarios both in the course playing the game and during its subsequent analysis. The apparatus of the present invention may be provided with a means for registering player's actions and state of game at any point of the game selected by the player, and the analyzing module recorded on the data carrier may comprise means for determining new game conditions not replicating the precedent ones for replaying a game event or the game as a whole but with new psychological guidelines, and means for determining those combinations of the components of an individual psychophysical profile of player's personality and matrix of event reaction thereof which are inconsistent with successful individual's activity in the sphere of human activities simulated by the game or mediately associated therewith.

An analyzing and correcting module is additionally recorded on the data carrier, whereon computer game software has been recorded beforehand, said module being aimed at monitoring player's actions and comparing them with the corresponding aspects of an individual psychophysical profile of player's personality and matrix of event reaction thereof, determining, just for the given particular player, the key points of the game which determine selecting some actions or other by the player so as to set a further course of the game, and generating instructions for writing player's actions and state of game at said key points. The module recorded on the data carrier comprises means for retrospective step-by-step analysis of player's actions that determine what of said actions would be optimal at said key points of the game and identify combinations of components of individual psychophysical profile of player's personality and matrix of event reaction thereof, which combinations have been to a maximum extent responsive for a non-optimal choice made by the player, means for generating new game conditions not replicating the precedent ones for replaying a game event or the game as a whole but with new psychological guidelines, and means for determining those combinations of the components of an individual psychophysical profile of player's personality and matrix of event reaction thereof which are inconsistent with successful individual's activity in the sphere of human activities simulated by the game or mediately associated therewith. The module under consideration may appear both as a self-contained software or firmware component of new games and as a software shell for the programs and algorithms of the already existing computer games.

The apparatus of the present invention comprises a data carrier 1 whereon a software 2 for computer games is recorded, a means 3 for testing a player for determining an individual psychophysical profile of player's personality and a matrix of event reaction thereof, a means 4 for generating instructions for playing the game, a means 5 for monitoring player's actions and comparing them with the corresponding aspects of the individual psychophysical profile of the player's personality and of the matrix of the event reaction thereof, a means 6 for identifying combinations of the components of an individual psychophysical profile of player's personality and matrix of event reaction thereof, said combinations yielding one result or another, and a means 7 for creating the appropriate messages and recommendations on correcting player's behavioral strategy. The apparatus further comprises a means 8 for imparting to the game characters the traits of an individual psychophysical profile of player's personality and of the matrix of event reaction thereof, said means, together with said means 5 for monitoring player's actions and comparing them with the corresponding aspects of the individual psychophysical profile of the player's personality and of the matrix of the event reaction thereof, said means 6 for identifying combinations of the components of an individual psychophysical profile of player's personality and matrix of event reaction thereof, and said means 7 for creating the appropriate messages and recommendations on correcting player's behavioral strategy on said data carrier, is essentially an analyzing and correcting module 9 additionally recorded on the data carrier 1, said module 9 further comprising a means 10 for determining those key points of the game which dictate selecting, by the player, some actions or other setting further course of the game, and generating instructions for recording player's actions and state of the game at said key points thereof. The apparatus further comprises a means 11 for storing the recorded player's actions and state of the game, said means 11 being connected to a respective means 12 for recording player's actions. Player's actions and state of the game may be recorded at any game point selected by the player.

The analyzing module 9 recorded on the data carrier further comprises a means 13 for generating new game conditions not replicating the precedent ones, for replaying a game event or the game as a whole but with new psychological guidelines, as well as a means 14 for determining combinations of the components of an individual psychophysical profile of player's personality and of the matrix of event reaction thereof inconsistent with successful individual's activity in the sphere of human activities simulated by the game. The apparatus is established on the basis of firmware complexes making use of personal computers. A variety of telecommunication and computer networks of any type may also be used, e.g., INTERNET.

Working out player's behavioral strategy using cognitive virtual reality, according to the present invention, is effected as follows.

First, a player is tested for individual psychophysical profile of his/her personality and matrix of event reaction thereof. Testing may be performed either explicitly for the player before beginning the play or unnoticeably for him/her in the course of the game, wherein tests are the integral components thereof. Hence the course of game is compared, practically from the very beginning thereof, with specific combinations of the components of an individual psychophysical profile of player's personality and of the matrix of event reaction thereof. Program elements that characterize the game characters, objects and definite processes are compared with the testing results concerning some or other characters, objects or processes of the game, thus imparting to some characters or other the definite components of an individual psychophysical profile of player's personality and of the matrix of event reaction thereof. During the game itself players actions are traced and compared with one or the other aspects of an individual psychophysical profile of player's personality and of the matrix of event reaction thereof. In addition, proceeding from player's manipulations with the characters or any objects of the game, there are identified the game key points for a given particular player, which key points determine his/her further selection of strategy of the game and any actions decisive for game course at subsequent stages thereof. It is at said key points that player's manipulations with the game characters and objects selected by the analyzing and correcting module, and the state of game are recorded and stored on a data carrier (in the computer). A special analyzing and correcting module monitors, in the course of the game, player's manipulations with the characters or any objects of the game and compares them with definite properties of player's personality and current behavioral strategy thereof. Hence psychophysical qualities of player's personality and of the matrix of event reaction thereof are transferred onto the characters and objects of the game, as well as methods of their representation in the game as graphic, audio, tactile, linguistic and other game components and also game parameters and/or scenarios, whereupon the parameters of said transferring are recorded both in the course of the game and during its subsequent analysis. Information about what qualities of player's personality and combinations thereof, and possible combinations of the components of an individual psychophysical profile of player's personality and of the matrix of event reaction thereof have yielded one result or the other and have been to a maximum extent responsive for a non-optimal choice made by the player, along with recommendations for correcting player's behavioral strategy, are issued to a user (e.g., to the player himself or to a person who tests the player for occupational fitness, etc.). Alongside with the key points of the game identified by the analyzing and correcting module, the player or a person performing testing and/or correction may independently choose those instants of time at which his/her actions and the state of game will be additionally recorded. The player (or another person) also may carry out a retrospective step-by-step analysis of the player's actions carried out during the game and determine what player's actions would be optimal at said game key points. At the same time, the analyzing and correcting module finds those combinations of the components of an individual psychophysical profile of player's personality and of the matrix of event reaction thereof which have been to a maximum extent responsive for a non-optimal choice made by the player. When replaying a game event or the game as a whole with new conditions not replicating the precedent ones which will be carried out but with new psychological and psychophysical guidelines, the player will execute his/her enhanced and improved behavioral strategy in the sphere of human activities simulated by the game or mediately associated therewith. When determining occupational fitness of a player, an analysis and comparison of his/her manipulations with the characters or with any game objects at various key points of the game during a number of game rounds or events thereof enables one to reliably identify what player's personality components are inconsistent with successful individual's activity in the sphere of human activities simulated by the game or mediately associated therewith, whereupon the appropriate conclusions and recommendations are presented.

Hence when managing and playing games of the aforementioned type, player's behavioral strategies found in the course of game are compared with those which the player uses or could use in real life. As a result, there are issued recommendations on what more efficient behavioral strategies exist nowadays:
(a) for a given particular player in his/her present psychophysical state and with the now-existing realization techniques;
(b) whenever an optimum correction of the psychophysical profile and of the matrix of event reaction of a given player occurs.

1. A method for working out player's behavioral strategy using cognitive virtual reality, wherein individual psychophysical profile of a player's personality and matrix of event reaction thereof are determined by testing effected either explicitly for the player before beginning the game or during the game, being unnoticed by the player when the tests are the game components;
an individual psychophysical profile of a player's personality and matrix of event reaction thereof are determined and instructions for playing the game are generated, while in the course of the game itself, player's actions are traced and compared with the corresponding aspects of the individual psychophysical profile of the player's personality and matrix of the event reaction thereof;
on the basis of said data there are then determined what player's personal qualities and combinations thereof have given one result or another; next said data are delivered together with recommendations for correcting player's behavioral strategy, wherein there is formed, with due account of player's matrix of event reaction, a character or a group of characters of the play and imparting to said character or group of characters the traits of player's individual psychophysical profile;
there are established the game parameters taking into account said matrix and preset properties of player's individual psychophysical profile;
there are determined, proceeding from player's manipulating game characters or any game objects, those game points which are key ones for a given particular player and determine actions selected by the player and setting a further course of the game;
actions performed by the player at said key points of the game and the state of the game; and
player's personal qualities are determined at said key points or combinations thereof yielding an appropriate result.

2. The method of claim 1, wherein player's actions with respect to the game characters or any game objects, as well as state of game are recorded at any game instant preselected by the player.

3. The method as claimed in claim 1, wherein there is carried out a retrospective step-by-step analysis of player's actions, there are determined player's actions that would be optimal at said game key points, and there are found the combinations of components of individual psychophysical profile of player's personality and the player's matrix of event reaction thereof, which combinations have been to a maximum extent responsive for a non-optimal choice made by the player.

4. The method as claimed in claim 1, wherein there are determined new game conditions that do not replicate the precedent ones for replaying a game event or the game as a whole but with new psychological guidelines.

5. The method as claimed in claim 1, wherein in the case of a number of game rounds or events thereof there are determined what combinations of components of individual psychophysical profile of player's personality and of matrix of event reaction thereof are inconsistent with successful individual's activity in the sphere of human activities simulated by the game or immediately associated therewith, whereupon the appropriate conclusions and recommendations are presented.

6. An apparatus for working out player's behavioral strategy using cognitive virtual reality, comprising
a data carrier whereon there is recorded software for computer games;
means for player's testing effected either explicitly for the player before beginning the game, or in the course of the game, being unnoticed by the player when the tests are the game components, aimed at determining individual psychophysical profile of the player's personality and matrix of event reaction thereof;
means for generating instructions for the game;
means for monitoring player's actions with respect to the game characters or any game objects and comparing said actions with the definite aspects of the individual psychophysical profile of the player's personality and matrix of the event reaction thereof;
means for identifying personal qualities or combinations thereof yielding one result or another; and
means for establishing appropriate messages regarding player's psychophysical state and correcting the player's behavioral strategy at key points of the game or, against player's request, at any other game instants and issuing appropriate messages to the player with or without interrupting the game, using appropriate linguistic formulas and visual aids built-in for issuing messages, without interrupting the game, to scenarios, topics, actions of characters, objects, graphic, audio and any other game components, wherein an analyzing and correcting module is recorded on said data carrier or additional record carrier, said module being aimed at comparing and correlating the appropriate properties and parameters of individual psychophysical profile of player's personality and matrix of event reaction thereof with the game characters, objects and components in order to create a character or a group of characters of the game by imparting to said character or a group of characters the traits of individual psychophysical profile of player's personality and matrix of event reaction thereof, as well as those of the game objects and processes with due account of the above said traits, said module further comprising said means for monitoring player's actions with regard to the game characters or any objects thereof and comparing these with the aspects of individual psychophysical profile of player's personality and matrix of event reaction thereof, identifying personal qualities or combinations thereof resulting in selecting by the player some actions or other dictating one game course or another, creating, on the data carrier, appropriate messages and recommendations on correcting player's behavioral strategy, as well as a means for determining those game points which are key ones for a given particular player after which further game parameters and/or scenarios, ways of its organization, representation and interaction of game characters and objects, as well as means for game realization comprising graphic, audio and other components thereof, are determined depending on player's behavioral strategy displayed by the player's with regard to characters or other objects of the behavioral strategy depending on properties and parameters of player's psychophysical profile and matrix of event reaction thereof, generating instructions for recording player's actions and state of game at both said key points of the game and those arbitrarily selected by the player;
the apparatus further comprises a storage means for recorded player's actions and state of game, while said means for identifying player's personal qualities or combinations thereof yielding an appropriate result, is capable of identifying said qualities or combinations thereof at any instant arbitrarily selected by the player and at key points of the game determined automatically by said analyzing and correcting module by comparing and correlating definite properties and parameters of an individual psychophysical profile of player's personality and matrix of event reaction thereof with both the player's actions regarding game characters and objects, and methods for organization, representation and interaction of the game characters or objects, as well as a means for game realization, including graphic, audio and any other game components and game parameters and/or scenarios both in the course playing the game and during its subsequent analysis.

7. The apparatus of claim 6, wherein it is provided with a means for recording player's actions and the state of game at any point of the game selected by the player.

8. The apparatus as claimed in claim 6, wherein the analyzing and correcting module comprises means for determining new game conditions not replicating the precedent ones for replaying a game event or the game as a whole but with new psychological guidelines.

9. The apparatus as claimed in claim 6, wherein the analyzing and correcting module comprises means for determining those combinations of the components of an individual psychophysical profile of player's personality and of the matrix of event reaction thereof which are inconsistent with successful individual's activity in the sphere of human activities, and means for presenting appropriate conclusions and recommendations.

10. A data carrier, wherein computer game software has been recorded beforehand, wherein additionally recorded thereon is an analyzing and correcting module aimed at monitoring player's actions and comparing them with the corresponding aspects of an individual psychophysical profile of player's personality and matrix of event reaction thereof, determining, just for the given particular player, the key points of the game which determine selecting some actions or other by the player so as to set a further course of the game, and generating instructions for writing player's actions and state of game at said key points of the game.

11. The data carrier of claim 10, wherein said analyzing and correcting module comprises means for retrospective step-by-step analysis of player's actions that determine what of said actions would be optimal at said key points of the game and identify combinations of components of individual psychophysical profile of player's personality and matrix of event reaction thereof, which combinations have been to a maximum extent responsive for a non-optimal choice made by the player.

12. The data carrier of claim 11, wherein said analyzing and correcting module comprises means for generating new game conditions not replicating the precedent ones for replaying a game event or the game as a whole but with new psychological and psychophysical guidelines.

13. The data carrier of claim 11, wherein said analyzing and correcting module comprises means for determining those combinations of the components of individual psychophysical profile of player's personality and of matrix of event reaction thereof which are inconsistent with successful individual's activity in the sphere of human activities simulated by the game or immediately associated therewith.

14. The data carrier as claimed in claim 10, wherein said analyzing and correcting module appears as a software shell for the programs and algorithms of the already existing computer games.

15. The data carrier as claimed in claim 10, wherein said analyzing and correcting module is recorded on a data carrier of its own or on an individual server when the game performed using local or global telecommunication or computer networks of any type or kind.

16. The method as claimed in claim 4, wherein in the case of a number of game rounds or events thereof there are determined what combinations of components of individual psychophysical profile of player's personality and of matrix of event reaction thereof are inconsistent with successful individual's activity in the sphere of human activities simulated by the game or immediately associated therewith, whereupon the appropriate conclusions and recommendations are presented.

17. The method as claimed in claim 3, wherein in the case of a number of game rounds or events thereof there are determined what combinations of components of individual psychophysical profile of player's personality and of matrix of event reaction thereof are inconsistent with successful individual's activity in the sphere of human activities simulated by the game or immediately associated therewith, whereupon the appropriate conclusions and recommendations are presented.

18. The apparatus as claimed in claim 8, wherein the analyzing and correcting module comprises means for determining those combinations of the components of an individual psychophysical profile of player's personality and of the matrix of event reaction thereof which are inconsistent with successful individual's activity in the sphere of human activities, and means for presenting appropriate conclusions and recommendations.

19. The data carrier as claimed in claim 14, wherein said analyzing and correcting module is recorded on a data carrier of its own or on an individual server when the game performed using local or global telecommunication or computer networks of any type or kind.

20. The data carrier as claimed in claim 1 3, wherein said analyzing and correcting module is recorded on a data carrier of its own or on an individual server when the game performed using local or global telecommunication or computer networks of any type or kind.
